(19) United States
(12) Patent Application Publication
(10) Pub. No.: US 2020/0262007 A1
(43) Pub. Date: Aug. 20, 2020

(54) LASER WELDING METHOD OF DIE CAST MEMBER, METHOD FOR MANUFACTURING DIE CAST PRODUCT, AND DIE CAST PRODUCT

(71) Applicant: KABUSHIKI KAISHA TOSHIBA, Minato-ku (JP)

(72) Inventor: Tetsuo SAKAI, Taito (JP)

(73) Assignee: KABUSHIKI KAISHA TOSHIBA, Minato-ku (JP)

(21) Appl. No.: 16/789,501

(22) Filed: Feb. 13, 2020

(30) Foreign Application Priority Data
Feb. 20, 2019 (JP) 2019-028073

(51) Int. Cl. B23K 26/24; B23K 26/06

(52) U.S. Cl. CPC B23K 26/24; B23K 26/0604

(57) ABSTRACT

A laser welding method of a die cast member includes forming a first melted portion by irradiating a first laser beam on a planned welding portion including a contact surface between a first member and a second member, and welding the first member and the second member by forming a second melted portion by irradiating a second laser beam on the planned welding portion after the first melted portion is formed; the first member includes a metal; and the second member is formed by die casting. A width of the first melted portion is not more than half of a width of the second melted portion. A depth of the first melted portion is deeper than a depth of the second melted portion.

### CROSS-REFERENCE TO RELATED APPLICATIONS

This application is based upon and claims the benefit of priority from Japanese Patent Application No. 2019-028073, filed on Feb. 20, 2019; the entire contents of which are incorporated herein by reference.

### FIELD

Embodiments relate to a laser welding method of a die cast member, a method for manufacturing a die cast product, and the die cast product.

### BACKGROUND

A product may be manufactured by forming a metal member by die casting and by joining the metal member to another metal member by laser welding. In such a case, the productivity may decrease due to defects in the laser welding.

### BRIEF DESCRIPTION OF THE DRAWINGS

FIG. 1 is a flowchart showing a laser welding method of a die cast member according to a first embodiment;

FIG. 2A to FIG. 4B show the laser welding method of the die cast member according to the first embodiment;

FIG. 5 is a plan view showing a laser welding method of a die cast member according to a second embodiment;

FIG. 6 is a plan view showing a laser welding method of a die cast member according to a third embodiment; and FIG. 7 is a cross-sectional view showing a die cast product according to a fourth embodiment.

### DETAILED DESCRIPTION

A laser welding method of a die cast member according to an embodiment includes forming a first melted portion by irradiating a first laser beam on a planned welding portion including a contact surface between a first member and a second member, and welding the first member and the second member by forming a second melted portion by irradiating a second laser beam on the planned welding portion after the first melted portion is formed; the first member includes a metal; and the second member is formed by die casting. A width of the first melted portion is not more than half of a width of the second melted portion. A depth of the first melted portion is deeper than a depth of the second melted portion.

A method for manufacturing a die cast product according to an embodiment includes forming a first melted portion by irradiating a first laser beam on a planned welding portion including a contact surface between a first member and a second member, and welding the first member and the second member by forming a second melted portion by irradiating a second laser beam on the planned welding portion after the first melted portion is formed; the first member includes a metal; and the second member is formed by die casting. A width of the first melted portion is not more than half of a width of the second melted portion. A depth of the first melted portion is deeper than a depth of the second melted portion.

A die cast product according to an embodiment includes a first member, a second member, and a melted portion formed between the first member and the second member; the first member includes a metal; and the second member is formed by die casting and is welded to the first member. A protrusion that has a line configuration or a plurality of dot configurations is formed in a lower surface of the melted portion.

### First Embodiment

First, a first embodiment will be described.

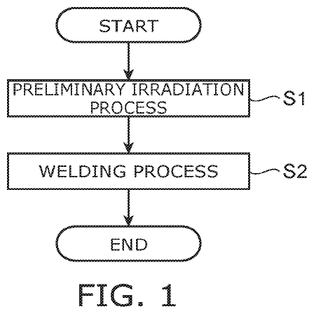

FIG. 1 is a flowchart showing a laser welding method of a die cast member according to the embodiment.

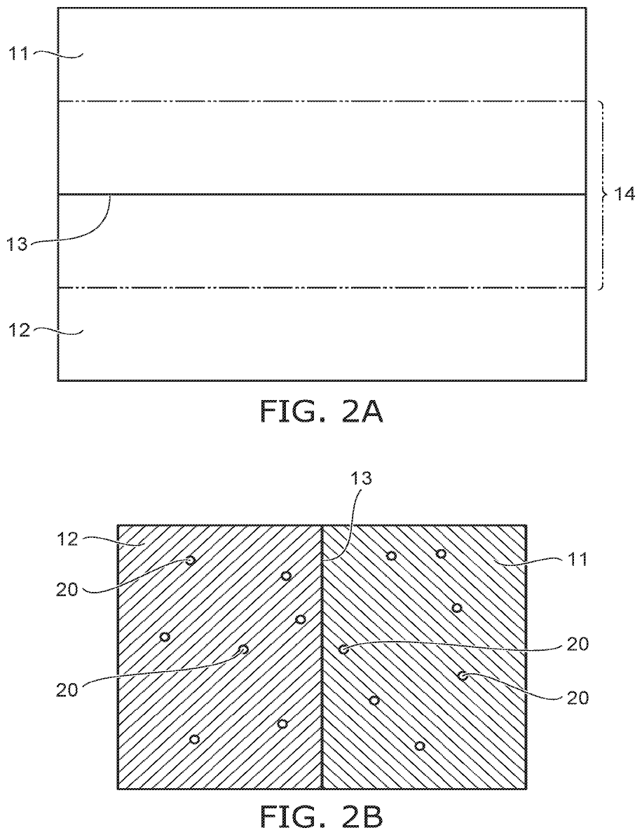

FIG. 2A to FIG. 4B show the laser welding method of the die cast member according to the embodiment.

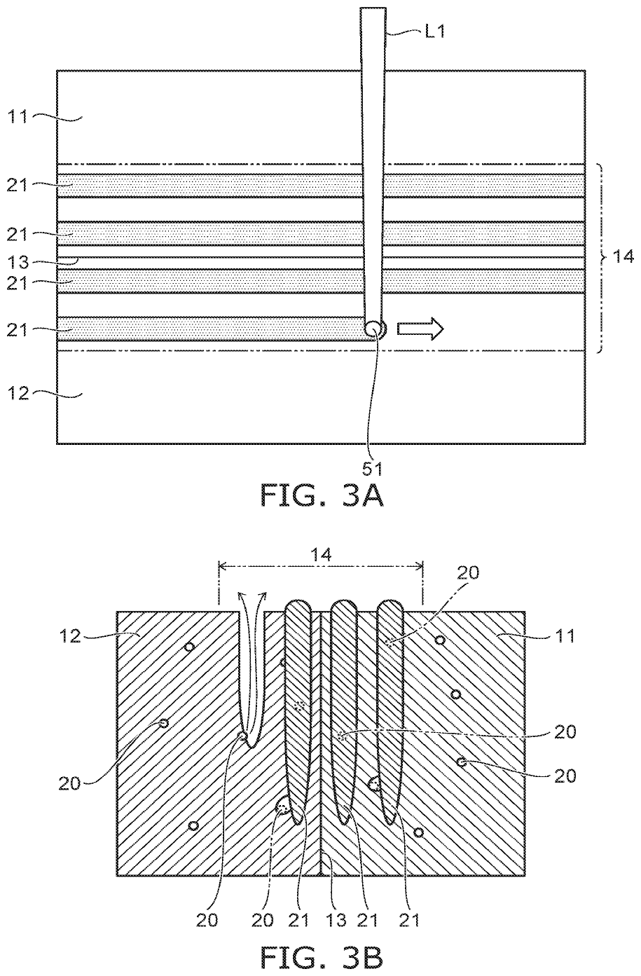

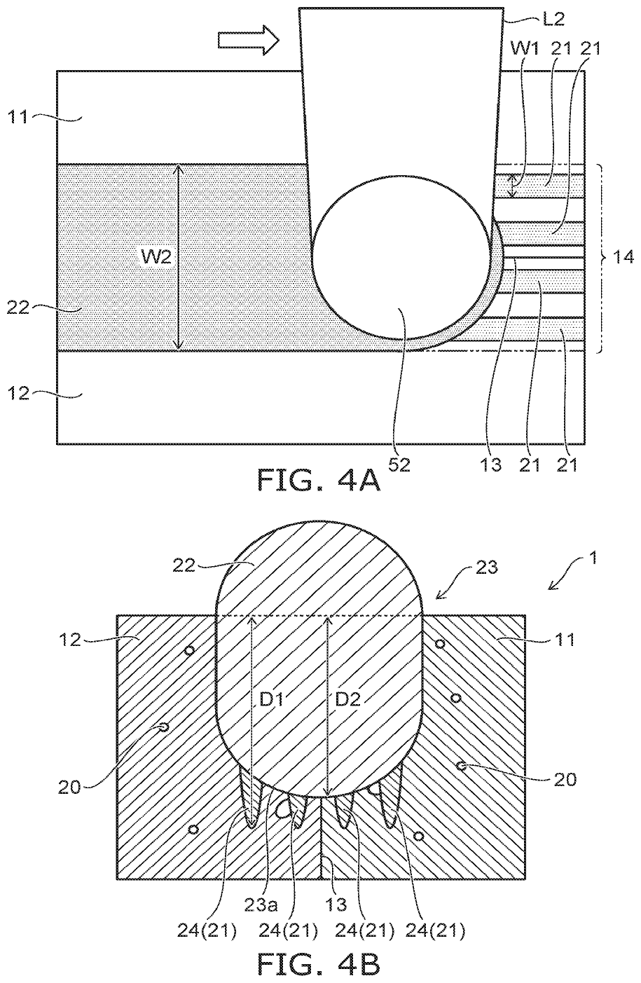

FIG. 2A is a plan view; and FIG. 2B is a cross-sectional view showing the same process as FIG. 2A. This is similar for FIGS. 3A and 3B and FIGS. 4A and 4B as well.

The laser welding method of the die cast member according to the embodiment is a portion of a method for manufacturing a die cast product. In the embodiment, the die cast product is manufactured by laser-welding a first member 11 and a second member 12. At least the second member 12 is a die cast member formed by die casting. Details will now be described.

First, the first member 11 and the second member 12 are prepared as shown in FIGS. 2A and 2B. The first member 11 and the second member 12 include metals and are made of, for example, aluminum or an aluminum alloy. The second member is a member formed by die casting and unavoidably includes voids 20 in the interior. The first member 11 may be a member formed by die casting or may be a member formed by another method. In the embodiment, the first member 11 also is formed by die casting. Therefore, the voids 20 are included unavoidably inside the first member 11 as well. Then, the first member 11 and the second member 12 are caused to contact each other. A portion that includes a contact surface 13 between the first member 11 and the second member 12 is set to be a planned welding portion 14.

Then, a preliminary irradiation process is performed as shown in step S1 of FIG. 1.

As shown in FIGS. 3A and 3B, a first laser beam L1 is irradiated on the planned welding portion 14. The first laser beam is, for example, a disk laser, a single-mode fiber laser, or a multimode fiber laser. For example, an irradiation region 51 of the first laser beam L1 is moved along the contact surface 13; and the movement is repeated multiple times. Or, multiple first laser beams L1 are irradiated simultaneously; and, for example, the multiple irradiation regions 51 are moved in parallel along the contact surface 13. The irradiation region 51 may be moved in a direction crossing the contact surface 13.

By irradiating the first laser beam L1, a portion of at least one of the first member 11 or the second member 12 is melted once and solidified. As a result, a first melted portion is formed in the planned welding portion 14. The configuration of the first melted portion 21 when viewed from above, i.e., the direction in which the first laser beam L1 is irradiated, is a pattern including a portion having multiple linear configurations. The width of the first melted portion 21 is not more than half of the width of the planned welding portion 14. The portion of the first melted portion 21 having the linear configurations may extend in a direction parallel to the contact surface 13. In such a case, the “widths” of the planned welding portion 14 and the first melted portion 21 are the lengths in a direction orthogonal to the contact surface 13.

When the first melted portion 21 is temporarily melted by the irradiation of the first laser beam L1, the gas that is inside the voids 20 formed in the first melted portion 21 and in the vicinity of the first melted portion 21 is ejected externally through the first melted portion 21 which is in a molten state. Thereby, the voids 20 disappear; or the interiors of the voids 20 are depressurized. The spacing of the irradiation region 51 of the first laser beam L1 is set so that the entire planned welding portion 14 is affected by the heat of the first laser beam L1, and all of the voids 20 existing inside the planned welding portion 14 disappear or are depressurized. The voids 20 that exist outside the planned welding portion 14 remain as-is without disappearing or being depressurized; but this is not a problem because the subsequent welding process is not affected.

Then, a welding process is performed as shown in step S2 of FIG. 1.

As shown in FIGS. 4A and 4B, a second laser beam L2 is irradiated on the planned welding portion 14 in which the first melted portion 21 is formed. The second laser beam L2 also is, for example, a disk laser, a single-mode fiber laser, or a multimode fiber laser. The diameter of an irradiation region 52 of the second laser beam L2 is larger than the diameter of the irradiation region 51 of the first laser beam L1. The diameter of the irradiation region 52 is, for example, not less than 2 times the diameter of the irradiation region 51. The irradiation region 52 is moved along the contact surface 13. By the irradiation of the second laser beam L2, a portion of the first member 11, a portion of the second member 12, and the upper portion of the melted portion 21 are melted once and subsequently solidified; and a second melted portion 22 is formed in the entire planned welding portion 14. Conversely speaking, the diameter of the irradiation region 52 is such that the melted portion 22 is formed in the entire planned welding portion 14 by moving the irradiation region 52 once.

A width W1 of the first melted portion 21 is not more than half of a width W2 of the second melted portion 22. For example, the width W2 of the second melted portion 22 is 1 mm (millimeters) or less; and the width W1 of the first melted portion 21 is 0.2 mm or less. Portions of the first melted portion 21 and the second melted portion 22 protruding from the upper surfaces of the first member 11 and the second member 12 become beads; therefore, the widths of the first melted portion 21 and the second melted portion 22 respectively are substantially equal to the widths of the beads. A depth D1 of the first melted portion 21 is deeper than a depth D2 of the second melted portion 22. In the specification, the “depth” is the distance from the surface of the first member 11 or the second member 12 on which the laser beam is irradiated.

Thus, the second melted portion 22 is formed; and a die cast product 1 is manufactured by the welding of the first member 11 and the second member 12. The first member 11 that includes a metal and the second member 12 that is formed by die casting and includes a metal are provided in the die cast product 1. For example, the first member 11 and the second member 12 are made of aluminum or an aluminum alloy. The second member 12 is laser-welded to the first member 11.

A melted portion 23 is formed between the first member 11 and the second member 12 to straddle the contact surface 13. The melted portion 23 is the first melted portion 21 and the second melted portion 22 described above formed as one body. A protrusion 24 that has a line configuration is formed at a lower surface 23a of the melted portion 23. The protrusion 24 is the lower portion of the first melted portion 21, i.e., the portion of the first melted portion 21 that does not become a portion of the second melted portion 22.

Effects of the embodiment will now be described.

In the embodiment, the first laser beam L1 is irradiated on the planned welding portion 14 in the process shown in FIGS. 3A and 3B. Thereby, the gas that is sealed in the voids 20 formed in the first melted portion 21 and in the vicinity of the first melted portion 21 is ejected externally through the melted portion 21 which is in a molten state. As a result, the voids 20 disappear; or the interiors of the voids 20 are depressurized drastically. At this time, the diameter of the first laser beam L1 is sufficiently small with respect to the planned welding portion 14; and the volume of the first melted portion 21 also is sufficiently small; therefore, the first member 11 and the second member 12 are not damaged greatly by the release of the gas from the voids 20. On the other hand, the depth of the first melted portion 21 is deeper than the depth of the second melted portion 22 formed subsequently; therefore, all of the voids 20 that may obstruct the formation of the second melted portion 22 disappear or are made harmless by being depressurized.

Subsequently, the second laser beam L2 is irradiated on the planned welding portion 14 in the process shown in FIGS. 4A and 4B. Thereby, the first member 11 and the second member 12 are welded; and the die cast product 1 is manufactured. At this time, the voids 20 that are formed in the planned welding portion 14 disappear or are depressurized; therefore, the scattering of the melted portion 22 caused by the voids 20 can be suppressed. Therefore, defective parts that are caused by the voids 20 do not occur easily; and the productivity of the die cast product 1 is high.

If the welding process of irradiating the second laser beam L2 is performed immediately without performing the preliminary irradiation process of irradiating the first laser beam L1, the voids 20 in which high-pressure gas is sealed contact the melted portion 22 which is in a molten state. It is estimated that the gas inside the voids 20 is sealed when die casting, or is a gas produced by residue inside the voids 20 sublimating due to the irradiation of the second laser beam L2. According to simulations of the inventors, the pressure inside the voids 20 on which the preliminary irradiation process is not performed is, for example, about 300 atmospheres. The melted portion 22 that is in the molten state is scattered by such a high-pressure gas. Because the volume of the melted portion 22 is large, the scattering amount also is large; and large defects such as recesses, holes, etc., are formed in the first member 11 and the second member 12.

If the defects such as recesses, holes, etc., are too large, the die cast product cannot be repaired by double laser welding, build-up welding, etc., and becomes a defective part. Therefore, the productivity of the die cast product decreases. In particular, when the die cast product to be manufactured is a sealed container such as the housing of a hard disk drive, it is difficult to repair a hole by performing additional laser welding because there is a possibility that the internal members provided inside the sealed container may be damaged. Also, when the die cast product is small, the repair is difficult because the defects formed by the scattering of the voids 20 are relatively large.

Conversely, according to the embodiment, first, the voids 20 are made harmless or caused to disappear by the first laser beam L1 having the small diameter; subsequently, the welding is performed by the second laser beam L2; therefore, the defects that are caused by the voids 20 can be suppressed; and the productivity of the die cast product 1 can be increased.

### Second Embodiment

A second embodiment will now be described.

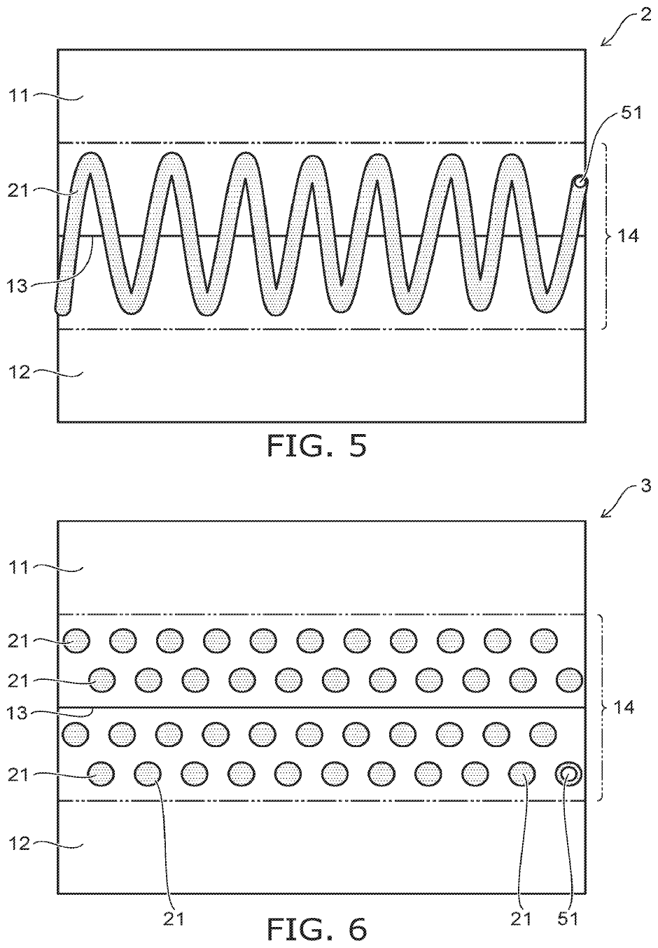

FIG. 5 is a plan view showing a laser welding method of a die cast member according to the embodiment.

In the embodiment as shown in FIG. 5, the irradiation region 51 of the first laser beam L1 is moved with respect to the planned welding portion 14 so that the first melted portion 21 has one curved configuration. For example, the path of the irradiation region 51 is a meandering curve. However, the path of the irradiation region 51 is not limited to a meandering curve; and it is sufficient for the thermal effects on the entire planned welding portion 14 to be such that the voids 20 disappear or are made harmless. It is favorable for the path of the irradiation region 51 to be a curve made by “one stroke.” Thereby, the irradiation time of the first laser beam L1 can be shortened; and the productivity of the die cast product can be improved further.

Otherwise, the laser welding method of the embodiment is similar to that of the first embodiment described above. In other words, after the voids 20 are depressurized or caused to disappear by the first laser beam L1, the first member 11 and the second member 12 are welded by irradiating the second laser beam L2. In such a case, the width of the first melted portion 21 formed by the first laser beam L1 is set to be not more than half of the width of the second melted portion 22 formed by the second laser beam L2; and the depth of the first melted portion 21 is set to be deeper than the depth of the second melted portion 22.

In the die cast product 2 thus manufactured, a protrusion that has one curved configuration is formed at the lower surface of the melted portion. Otherwise, the configuration and the effects of the die cast product of the embodiment are similar to those of the first embodiment.

### Third Embodiment

A third embodiment will now be described.

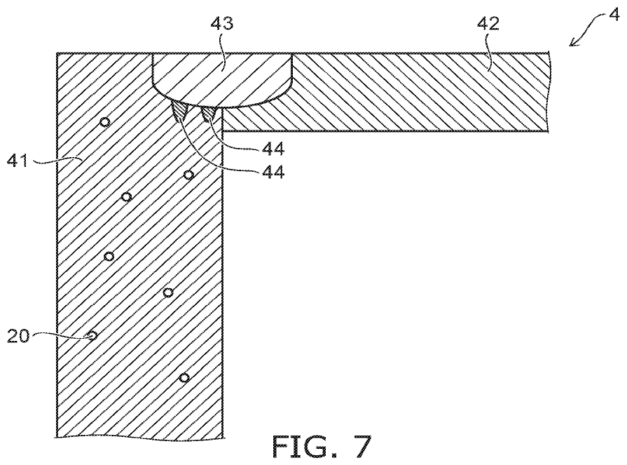

FIG. 6 is a plan view showing a laser welding method of a die cast member according to the embodiment.

In the embodiment as shown in FIG. 6, the irradiation region 51 is moved with respect to the planned welding portion 14 so that the first melted portion 21 includes a portion having multiple dot configurations. For example, the first laser beam L1 is irradiated in pulses while moving the irradiation region 51 with respect to the first member 11 and the second member 12. In such a case as well, the disposition of the irradiation region is controlled so that the thermal effects on the entire planned welding portion 14 are such that the voids 20 can be depressurized or caused to disappear. It is favorable for the irradiation region 51 to be arranged periodically.

In a die cast product 3 thus formed, multiple protrusions having dot configurations are formed at the lower surface of the melted portion. The protrusions may be arranged periodically. Otherwise, the configuration and the effects of the laser welding method and the die cast product of the embodiment are similar to those of the first embodiment.

### Fourth Embodiment

A fourth embodiment will now be described.

FIG. 7 is a cross-sectional view showing a die cast product according to the embodiment.

As shown in FIG. 7, a die cast product 4 according to the embodiment is a sealed container, e.g., a housing of a hard disk drive. A housing 41 and a lid 42 laser-welded to the housing 41 are provided in the die cast product 4. The housing 41 has a box configuration with an open upper surface. The lid 42 is welded to the upper surface of the housing 41. The housing 41 is formed by die casting, is made of a metal, and includes, for example, aluminum. For example, the lid 42 is formed by pressing, is made of a metal, and includes, for example, aluminum. Accordingly, the housing 41 unavoidably includes the voids 20; but the lid 42 does not include the voids 20.

The welding method of the housing 41 and the lid 42 is similar to the first, second, or third embodiment described above. However, it is unnecessary to irradiate the first laser beam L1 on the lid 42 because the lid 42 does not include the voids 20.

In the die cast product 4, a melted portion 43 is formed in the welded portion between the housing 41 and the lid 42. A protrusion 44 is formed at the lower surface of the melted portion 43. The protrusion 44 is formed only inside the housing 41 and is not formed inside the lid 42. For example, the protrusion 44 has a line configuration. For example, the protrusion 44 may have multiple linear configurations or may have one curved configuration. Or, the protrusion 44 may have periodically-arranged multiple dot configurations. The first laser beam L1 may be irradiated also on the lid 42. In such a case, the protrusion 44 is formed also inside the lid 42.

Although examples of butt welding are shown in the first to fourth embodiments described above, the invention is not limited thereto. For example, the invention also is applicable to lap welding and fillet welding.

According to the embodiments described above, a laser welding method of a die cast member, a method for manufacturing a die cast product, and a die cast product can be realized in which the productivity can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Additionally, the embodiments described above can be combined mutually.

What is claimed is:

1. A laser welding method of a die cast member, comprising:
forming a first melted portion by irradiating a first laser beam on a planned welding portion including a contact surface between a first member and a second member, the first member including a metal, the second member being formed by die casting; and
welding the first member and the second member by forming a second melted portion by irradiating a second laser beam on the planned welding portion after the first melted portion is formed,
a width of the first melted portion being not more than half of a width of the second melted portion,
a depth of the first melted portion being deeper than a depth of the second melted portion.

2. A method for manufacturing a die cast product, comprising:
forming a first melted portion by irradiating a first laser beam on a planned welding portion including a contact surface between a first member and a second member, the first member including a metal, the second member being formed by die casting; and
welding the first member and the second member by forming a second melted portion by irradiating a second laser beam on the planned welding portion after the first melted portion is formed,
a width of the first melted portion being not more than half of a width of the second melted portion,
a depth of the first melted portion being deeper than a depth of the second melted portion.

3. The method according to claim 2, wherein the first melted portion includes a portion having a plurality of linear configurations.

4. The method according to claim 2, wherein the first melted portion has one curved configuration.

5. The method according to claim 2, wherein the first melted portion includes a portion having a plurality of dot configurations.

6. The method according to claim 2, wherein the second melted portion has a line configuration along the contact surface.

7. A die cast product, comprising:
a first member including a metal;
a second member formed by die casting and welded to the first member; and
a melted portion formed between the first member and the second member,
a protrusion having a line configuration or a plurality of dot configurations and being formed in a lower surface of the melted portion.

8. The product according to claim 7, wherein the product is a sealed container.

9. The product according to claim 7, wherein the product is a housing of a hard disk drive.
